(19) United States
(12) Patent Application Publication
(10) Pub. No.: US 2006/0291028 A1
(43) Pub. Date: Dec. 28, 2006

(54) Laser scanning unit for splitting multiple light beams in a tandem image forming apparatus

(75) Inventor: Yeon-kyu Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/366,508

(22) Filed: Mar. 3, 2006

(30) Foreign Application Priority Data
Jun. 28, 2005 (KR) 10-2005-0056257

(51) Int. Cl. G02B 26/08

(52) U.S. Cl. 359/216; 359/204

(57) ABSTRACT

A laser scanning unit for an image forming apparatus includes a light source for producing and projecting light beams, a polygon mirror for deflecting the light beams, a beam splitter for splitting the light beams deflected by the polygon mirror, and an image forming lens arrangement for compensating for aberration of the light beams split by the splitter. The beam splitter has a convex cylindrical mirror and a concave cylindrical mirror, which are paired with each other. The configuration of the splitter allows a more compact arrangement.

### CROSS-REFERENCE TO RELATED APPLICATIONS

This application claims the benefit under 35 U.S.C. § 119(a) of Korean Patent Application No. 2005-56257, filed on Jun. 28, 2005, in the Korean Intellectual Property Office, the entire disclosure of which is hereby incorporated by reference.

### BACKGROUND OF THE INVENTION

1. Field of the Invention

The present invention relates to a laser scanning unit. More particularly, the present invention relates to a compact laser scanning unit which has an improved capability for splitting multiple light beams in a tandem image forming apparatus.

2. Description of the Related Art

In a tandem image forming apparatus, for example, an image forming apparatus such as a color laser printer, a color digital copying machine or the like, an image is formed by exposing a plurality of photoconductors which are scanned by multiple laser beams, instead of by a single laser beam, to accelerate the function of the apparatus. When a color image is formed by laser scanning, four photoconductors (for example, Y (yellow), M (magenta), C (cyan), and K (black)) are typically required. In a tandem scanning optical system for forming an image on four photoconductors, multiple beams are generally caused to be incident on a polygon mirror at various tilt angles. The polygon mirror scans the beams in a main-scanning direction, and the light paths are then separated in the sub-scanning direction.

A conventional scanning optical system which employs a multi-beam light source is disclosed in Japanese Unexamined Patent Publication No. 2003-75752, which is hereby incorporated by reference in its entirety. That publication discloses a tandem laser scanning unit that emits four respective laser beams LY, LM, LC, and LK from respective light sources. The beams are incident on and deflected by a reflecting surface 2a of a polygon mirror 2 with different tilt angles, respectively, as shown in FIG. 1. Thereafter, the deflected laser beams pass through first and second lenses 3 and 4 and the deflected beams are split through corresponding splitter mirrors 7 and 8, thereby being scanned on respective photoconductors 6Y, 6M, 6C and 6K.

In the laser scanning unit 1 set forth above, the respective laser beams LY, LM, LC and LK should be independent from each other and there should be a sufficient distance between adjacent laser beams to render the laser beams on the reflecting surface 2a of the polygon mirror 2 at different tilt angles. When parallel beams with a sufficient distance between adjacent beams are caused to be incident on and to be deflected by the polygon mirror 2, the beams are easily split, but the surface area of the polygon mirror 2 needs to be increased. In addition, the optical distance from the reflecting surface 2a of the polygon mirror 2 to the splitting mirrors 7Y, 7M and 7C must be long enough to secure a sufficient effective angle, that is, a sufficient split angle between laser beams. These requirements hamper the ability to develop a compact tandem laser scanning unit.

Accordingly, there is a need for an improved laser scanning unit which can efficiently split laser beams in a tandem laser scanning unit.

### SUMMARY OF THE INVENTION

An aspect of the present invention is to address at least the above problems and/or disadvantages and to provide at least the advantages described below. Accordingly, an aspect of the present invention is to provide a laser scanning unit which can efficiently split light beams from a light source by arranging a beam splitter between a polygon mirror and an image forming lens arrangement.

In accordance with an aspect of the present invention, a laser scanning unit includes a light source for producing and projecting light beams, a polygon mirror for deflecting the light beams, a beam splitter for splitting the light beams deflected by the polygon mirror, and an image forming lens arrangement for compensating aberration of the light beams split by the beam splitter.

The light source may be a multi-beam light source which produces multiple light beams from a single semiconductor element. Alternatively, the light source may be a plurality of single beam light sources. The light source may be a light emitting diode (LED) or a semiconductor laser diode (LD).

The beam splitter may comprise a first splitting mirror and a second mirror which are paired with each other. The first splitting mirror has a first reflecting surface, and the first reflecting surface forms a predetermined curvature R1 in the sub-scanning direction (Y-direction in FIG. 4). The first splitting mirror splits the light beams at different angles. The second mirror has a second reflecting surface opposite to the first splitting mirror. The second reflecting surface forms a predetermined curvature R2 in the sub-scanning direction and reflects the light beams toward the image forming lens arrangement.

The first splitting mirror may be a convex cylindrical mirror and the second splitting mirror may be a concave cylindrical mirror. The first splitting mirror may comprise one convex cylindrical mirror, and the second splitting mirror may comprise four concave cylindrical mirrors.

The space between the first and second splitting mirrors may be adjusted by the curvatures of the first and second splitting mirrors.

A collimating lens and a cylindrical lens may be positioned between the light source and the polygon mirror.

In accordance with another aspect of the present invention, a laser scanning unit comprises a multi-beam light source for producing and projecting light beams, a polygon mirror for deflecting the light beams, a pair of splitters each having a reflecting surface, the reflecting surfaces having a predetermined curvature in a sub-scanning direction so as to split the light beams deflected by the polygon mirror; and an image forming lens arrangement for compensating for aberration of the light beams split by the pair of splitters.

The pair of splitters may comprise a first splitting mirror for splitting the light beams at different angles, and a second splitting mirror disposed opposite to the first splitting mirror to reflect the light beams toward the image forming lens arrangement.

The first splitting mirror may be a convex cylindrical mirror and the second splitting mirror may be a concave cylindrical mirror.

The first splitting mirror may comprise one convex cylindrical mirror and the second splitting mirror may comprise four concave cylindrical mirrors.

The spacing between the first and second splitting mirrors may be adjusted by the curvatures of the first and second splitting mirrors.

In accordance with yet another aspect of the present invention, an image forming apparatus comprises a plurality of photoconductors for producing electrostatic latent images, the plurality of photoconductors rotating in a sub-scanning direction, a multi-beam light source for producing light beams, a polygon mirror for receiving light beams produced by the multi-beam light source and deflecting the light beams in a main-scanning direction, a first splitting mirror having a first reflecting surface with a predetermined curvature in the sub-scanning direction, the first splitting mirror receiving and deflecting light beams from the polygon mirror, and a second splitting mirror having a second reflecting surface, the second reflecting surface having a predetermined curvature in the sub-scanning direction. The second splitting mirror receives light beams deflected by the first splitting mirror and deflects the light beams toward the plurality of photoconductors to form electrostatic latent images on the plurality of photoconductors.

The first splitting mirror may be a convex cylindrical mirror and the second splitting mirror may be a concave cylindrical mirror.

The first splitting mirror may comprise one convex cylindrical mirror and the second splitting mirror may comprise four concave cylindrical mirrors.

The radius of curvature of the one convex cylindrical mirror may be constant.

The four concave cylindrical mirrors may have the same radii of curvature.

The four concave cylindrical mirrors have different radii of curvature.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic view of a conventional tandem laser scanning unit;

FIG. 2 is a schematic view of a laser scanning unit according to an exemplary embodiment of the present invention;

FIG. 3 is a perspective view of the laser scanning unit shown in FIG. 2;

FIG. 4A is a perspective view of a first splitting mirror of the laser scanning unit shown in FIG. 2; and

FIG. 4B is a perspective view of a second splitting mirror of the laser scanning unit shown in FIG. 2.

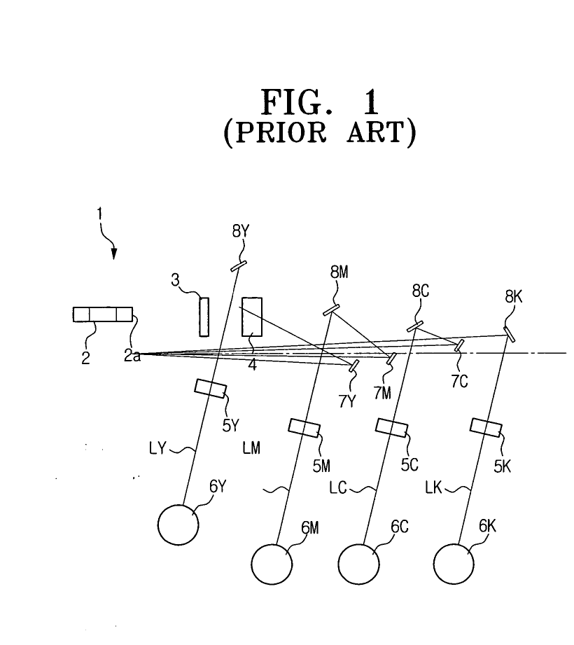

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention will now be described in detail, with reference to the accompanying drawings.

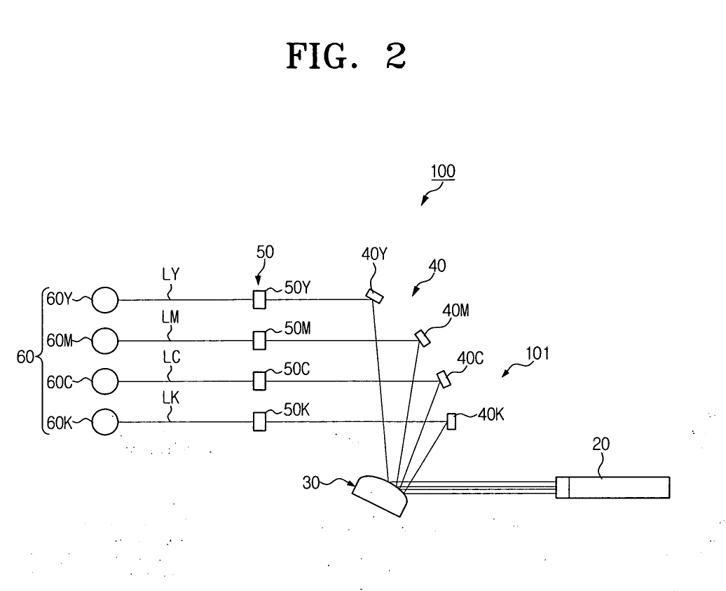

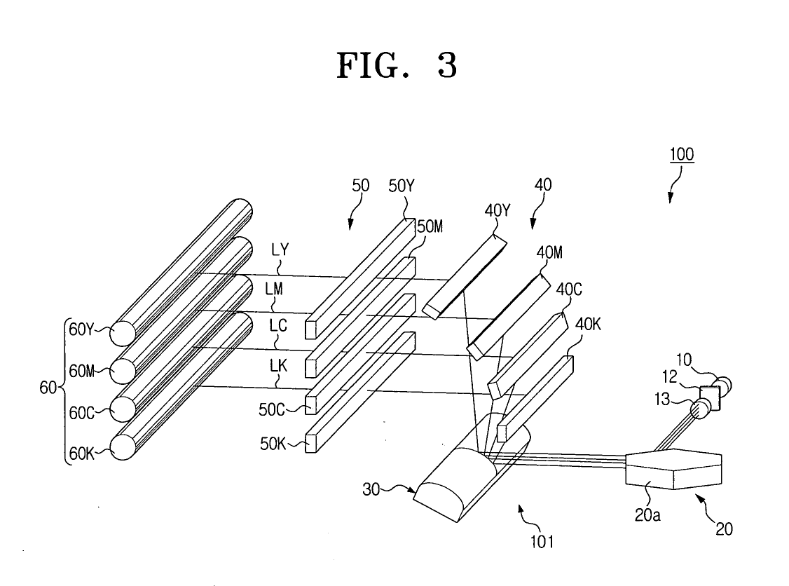

FIG. 2 is a schematic view of a laser scanning unit according to an exemplary embodiment of the present invention, and FIG. 3 is a perspective view of the laser scanning unit shown in FIG. 2. Referring to the drawings, a laser scanning unit 100 according to an exemplary embodiment of the present invention comprises a light source 10, a polygon mirror 20, a beam splitter 101, and an image forming lens arrangement 50.

The light source 10 produces and projects light beams LY, LM, LC and LK to a plurality of photoconductors 60. The plurality of photoconductors 60 comprises, for example, four photoconductors 60Y, 60M, 60C, and 60K corresponding to the light beams LY, LM, LC and LK, respectively. The light source 10 may be a light emitting diode (LED), a semiconductor laser diode (LD), or any other suitable light source known to one skilled in the art. The light source may comprise a plurality of single beam light sources, where each of the single beam light sources produces a single beam. The diameter of a light beam is typically about 40 μm. If a plurality of single beam sources are used, the spacing between adjacent light beams may be in the range of several millimeters to one (1) centimeter. With this spacing, it is not particularly difficult to split the light beams in a tandem laser scanning unit. In a laser scanning unit that uses a multi-beam-light source in which multiple light beams are produced from one semiconductor device, however, the spacing between adjacent beams is typically equal to or narrower than the diameter of each light beam. These closely spaced light beams may be difficult to separate. The laser scanning unit 100 according to an exemplary embodiment of the present invention, however, can effectively split such light beams. That is, the laser scanning unit 100 according to an exemplary embodiment of the present invention is particularly useful with a laser scanning unit that has a multi-beam light source in which the space between adjacent beams is very small. The combination of the laser scanning unit 100 according to an exemplary embodiment of the present invention with a multi-beam light source is advantageous because the entire space occupied by the laser scanning unit can be reduced.

The polygon mirror 20 deflects the light beams LY, LM, LC and LK emitted from the light source 10 in a main-scanning direction. If a multi-beam light source is used in the present invention, it is possible to substantially reduce the width of the reflecting surface 20a of the polygon mirror 20 because the spacing between adjacent light beams is narrow. Consequently, the reflecting surface 20a of the polygon mirror is not subject to the width requirements of a conventional apparatus, which means that it is possible to make the polygon mirror smaller and save manufacturing costs.

The laser scanning unit 100 according to an exemplary embodiment of the present invention may further comprise a collimating lens 12 and a cylindrical lens 13 positioned between the light source 10 and the polygon mirror 20.

The collimating lens 12 converts the light beams LY, LM, LC and LK emitted from the light source 10 into parallel beams or convergent beams. The cylindrical lens 13 focuses incident beams in the main-scanning direction and in the sub-scanning direction, so that the light beams are focused on the polygon mirror 20.

The laser scanning unit 100 of the present exemplary embodiment includes the beam splitter 101 for splitting the light beams LY, LM, LC and LK deflected by the polygon mirror 20.

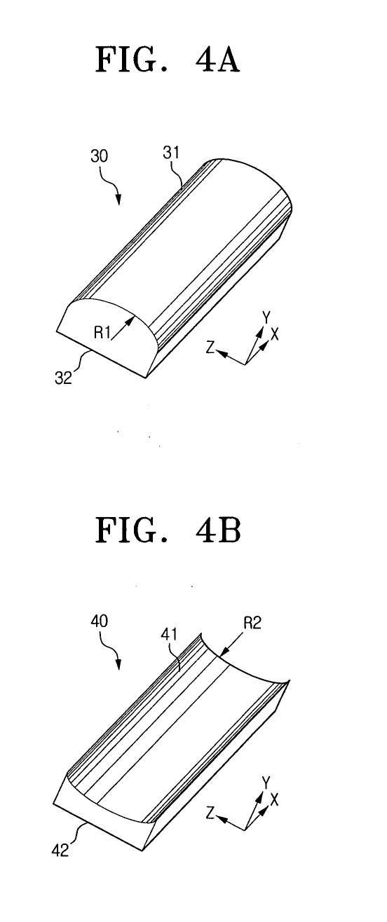

FIG. 4 shows the beam splitter 101 in detail, in which FIG. 4A shows a first splitting mirror 30 and FIG. 4B shows a second splitting mirror 40. Referring to the drawings, the beam splitter 101 comprises the first splitting mirror 30 and the second splitting mirror 40, which are paired with each other. The first mirror 30 and the second mirror 40 are configured in such a manner that each of them has a radius of curvature R1 or R2 in the sub-scanning direction (Y-direction).

The first splitting mirror 30 may be, for example, a cylindrical mirror, a first reflecting surface 31 of which is convex, so that the light beams, LY, LM, LC and LK are respectively split at different angles. Such a convex cylindrical mirror is formed with a curved surface of a curvature of radius R1 along the cylinder in the sub-scanning direction (Y-direction). The cylindrical mirror is substantially straight along the longitudinal direction of the cylinder (X-direction). The first reflecting surface 31 of the first splitting mirror 30 illustrated in FIG. 4A is convex while the opposite side is a substantially flat surface 32.

In the sub-scanning direction (Y-direction), the first splitting mirror 30 may have various curvatures, as desired, at the areas for reflecting corresponding light beams LY, LM, LC or LK, respectively. That is, the radii of curvature RY1, RM1, RC1 and RK1, which correspond to the radii of curvatures at the area where the light beams strike the first splitting mirror, may be different from each other.

The second splitting mirror 40 is disposed opposite to the first splitting mirror 30 and passes the light beams toward the image forming lens arrangement 50. The second splitting mirror 40 may be, for example, a concave cylindrical mirror. That is, the second reflecting surface 41 of the second splitting surface is concave, and has a radius of curvature R2 in the sub-scanning direction of the cylinder. The second splitting mirror is substantially straight in the longitudinal direction of the cylinder, like the above-described convex cylindrical mirror. The second reflecting surface 41 of the second splitting mirror 40 illustrated in FIG. 4B is concave while the opposite side is a substantially flat surface 42.

The second splitting mirror 40 may have various curvatures to correspond to the curvature of the first splitting mirror and the spacing between the first splitting mirror and the second splitting mirror. In other words, the radii of curvature RY2, RM2, RC2, and RK2 may be different from each other.

By changing the radii of curvatures R1 and R2 of the respective splitting mirrors 30 and 40, it is possible to adjust the spacing between the first and second splitting mirrors 30 and 40 in the beam splitter. For example, if the radius of curvature R1 of the first splitting mirror 30 is reduced, it is possible to reduce the spacing between the first and second splitting mirrors 30 and 40. As a result, depending on how the radius of curvature of each mirror of the beam splitter is formed, it is possible to reduce the space required for the beam splitter in the scanning unit, thereby allowing the laser scanning unit to be made more compact.

As shown in FIG. 3, a tandem laser scanning unit has aibeam splitter 101 comprising one convex cylindrical mirror 30 and four concave cylindrical mirrors 40Y, 40M, 40C and 40K. The four concave cylindrical mirrors may have different radii of curvatures, respectively.

The light beams split from the beam splitter 101 pass through an image forming lens arrangement 50, respectively, thereby forming an image on photoconductors 60, so that latent images are formed on the surfaces of the photoconductors 60.

The image forming lens arrangement 50 compensates the split light beams at different magnification in the main-scanning direction and in the sub-scanning direction. That is, the image forming lens arrangement 50 may comprise fθ lenses 50Y, 50M, 50C and 50 K, to compensate for aberration of the light beams LY, LM, LC and LK.

The procedure for splitting light beams with the laser scanning unit 100 will now be described.

The multi-beam light source 10 produces and projects light beams LY, LM, LC and LK through the collimating lens 12 and the cylindrical lens 13. The polygon mirror 20 rotates and deflects the light beams LY, LM, LC and LK in the main-scanning direction (X-direction in FIG. 4). The light beams deflected by the polygon mirror 20 are split at different angles by the convex cylindrical mirror 30 of the beam splitter 101. The split light beams are focused by the concave cylindrical mirror 40, the fθ lenses 50Y, 50M, 50C and 50K correct for aberration, and the light beams are scanned on the electrified photoconductors 60, respectively, to form latent images on the surfaces of the photoconductors 60.

As described above, because it is possible to use a multi-beam light source, the width of the surface of the polygon mirror can be significantly reduced, thereby saving manufacturing costs. Moreover, even though a multi-beam light source is used, the light beams can be securely split. Therefore, it is possible to remove restrictions concerning the minimum spacing between adjacent light beams and restrictions concerning the optical distance from the polygon mirror to the reflecting mirror. Consequently, the present invention is especially suitable for a compact tandem laser scanning unit.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A laser scanning unit comprising:
a light source for producing and projecting light beams;
a polygon mirror for deflecting the light beams;
a beam splitter for splitting the light beams deflected by the polygon mirror; and
an image forming lens arrangement for compensating for aberration of the light beams split by the beam splitter.

2. The laser scanning unit as claimed in claim 1, wherein
the light source is a multi-beam light source which produces multiple light beams from a single semiconductor element.

3. The laser scanning unit as claimed in claim 1, wherein
the light source comprises plural single beam light sources.

4. The laser scanning unit as claimed in claim 1, wherein
the light source comprises a light emission diode or a semiconductor laser diode.

5. The laser scanning unit as claimed in claim 1, wherein the beam splitter comprises:
a first splitting mirror having a first reflecting surface with a predetermined curvature in a sub-scanning direction, the first splitting mirror splitting the light beams at different angles; and
a second splitting mirror having a second reflecting surface disposed opposite to the first splitting mirror, the second reflecting surface having a predetermined curvature in the sub-scanning direction and reflecting the light beams toward the image forming lens arrangement.

6. The laser scanning unit as claimed in claim 5, wherein
the first splitting mirror is a convex cylindrical mirror and the second splitting mirror is a concave cylindrical mirror.

7. The laser scanning unit as claimed in claim 6, wherein
the first splitting mirror comprises one convex cylindrical mirror and the second splitting mirror comprises four concave cylindrical mirrors.

8. The laser scanning unit as claimed in claim 5, wherein
the spacing between the first and second splitting mirrors are adjusted by the curvatures of the first and second splitting mirrors.

9. The laser scanning unit as claimed in claim 1, further comprising
a collimating lens and a cylindrical lens positioned between the light source and the polygon mirror.

10. A laser scanning unit comprising:
a multi-beam light source for producing and projecting light beams;
a polygon mirror for deflecting the light beams;
a pair of splitters each having a reflecting surface, the reflecting surfaces having a predetermined curvature in a sub-scanning direction so as to split the light beams deflected by the polygon mirror; and
an image forming lens arrangement for compensating for aberration of the light beams split by the pair of splitters.

11. The laser scanning unit as claimed in claim 1.0, wherein the pair of splitters comprise:
a first splitting mirror for splitting the light beams at different angles; and
a second splitting mirror disposed opposite to the first splitting mirror to reflect the light beams toward the image forming lens arrangement.

12. The laser scanning unit as claimed in claim 11, wherein
the first splitting mirror is a convex cylindrical mirror and the second splitting mirror is a concave cylindrical mirror.

13. The laser scanning unit as claimed in claim 10, wherein
the first splitting mirror comprises one convex cylindrical mirror and the second splitting mirror comprises four concave cylindrical mirrors.

14. The laser scanning unit as claimed in claim 11, wherein
the spacing between the first and second splitting mirrors is adjusted by the curvatures of the first and second splitting mirrors.

15. An image forming apparatus comprising:
a plurality of photoconductors for producing electrostatic latent images, the plurality of photoconductors rotating in a sub-scanning direction;
a multi-beam light source for producing light beams;
a polygon mirror for receiving light beams produced by the multi-beam light source and deflecting the light beams in a main-scanning direction;
a first splitting mirror having a first reflecting surface with a predetermined curvature in the sub-scanning direction, the first splitting mirror receiving and deflecting light beams from the polygon mirror;
a second splitting mirror having a second reflecting surface, the second reflecting surface having a predetermined curvature in the sub-scanning direction, the second splitting mirror receiving light beams deflected by the first splitting mirror and deflecting the light beams toward the plurality of photoconductors to form electrostatic latent images on the plurality of photoconductors.

16. The laser scanning unit as claimed in claim 15, wherein
the first splitting mirror is a convex cylindrical mirror and the second splitting mirror is a concave cylindrical mirror.

17. The laser scanning unit as claimed in claim 15, wherein
the first splitting mirror comprises one convex cylindrical mirror and the second splitting mirror comprises four concave cylindrical mirrors.

18. The laser scanning unit as claimed in claim 17, wherein
a radius of curvature of the one convex cylindrical mirror is constant.

19. The laser scanning unit as claimed in claim 17, wherein
the four concave cylindrical mirrors have the same radii of curvature.

20. The laser scanning unit as claimed in claim 17, wherein
the four concave cylindrical mirrors have different radii of curvature.
